(19) United States
(12) Patent Application Publication
(10) Pub. No.: US 2026/0261614 A1
(43) Pub. Date: Sep. 3, 2026

(54) VOICE AUTHENTICATION BASED ON BACKGROUND AUDIO

(71) Applicant: Wells Fargo Bank, N.A., San Francisco, CA (US)

(72) Inventors: Michael J. Quinlan, San Francisco, CA (US); Nicholas Richard Gillis, Martinsburg, WV (US); Basil F. Nimry, West Des Moines, IA (US); Ajit Gaddam, Danville, CA (US)

(21) Appl. No.: 19/067,096

(22) Filed: Feb. 28, 2025

(51) Int. Cl. H04M 3/22; G06Q 40/02; G10L 17/02; G10L 25/51; G10L 25/69; H04M 3/42; H04M 3/51; H04M 9/08

(52) U.S. Cl. CPC H04M 3/2281; G10L 17/02; G10L 25/51; G10L 25/69; H04M 3/42221; H04M 3/5183; H04M 9/085; G06Q 40/02; H04M 2201/405

(57) ABSTRACT

Systems and techniques may generally be used for verifying a caller is authentic. An example technique may include receiving an authentication request during an audio call with a caller, playing, during the audio call, a set of sounds, capturing audio received from the caller during the audio call, and processing the audio to generate a voice portion including the voice data and to attempt to generate a background portion including a reverb of the set of sounds. The example technique may include determining whether the background portion including the reverb was generated, and in response to determining that the background portion including the reverb was not generated, outputting an indication denying the authentication request.

### BACKGROUND

Voice authentication systems capture and analyze unique characteristics in human speech to verify user identity. However, fraudsters may use voice identity spoofing to fake a user vice. These attack vectors may include a replay attack using pre-recorded voice sample, a voice synthesis using text-to-speech system, a voice conversion that transforms source speaker characteristic to match a target speaker, or an audio deepfake generated by a neural network. An attacker may capture a voice sample through a covert recording or public source, and then manipulate this recording using digital signal processing to match target frequency characteristic.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various examples discussed in the present document.

FIG. 1 illustrates a system diagram for voice authentication based on background audio in accordance with some examples.

FIG. 2 illustrates a background audio assessment workflow in accordance with some examples.

FIG. 3 illustrates example sound reverb time graphs in accordance with some examples.

FIG. 4 illustrates an audio processing workflow in accordance with some examples.

FIG. 5 illustrates a flowchart showing a technique for voice authentication based on background audio in accordance with some examples.

FIG. 6 illustrates generally an example of a block diagram of a machine upon which any one or more of the techniques discussed herein may perform in accordance with some examples.

### DETAILED DESCRIPTION

The systems and techniques described herein may be used to determine whether a user is live when providing audio for an authentication request. When authenticating a user, audio may be captured (e.g., of a user speaking generally, speaking a specific word, phrase, set of numbers, or the like). However, the audio may be faked, such as by playing a recording, spoofing the user's voice, etc. Audio captured of a user speaking live in an environment may include background noise, one or more acoustic features based on environmental factors (e.g., room size, wall material, etc.), or feedback. While checking for background noise may be useful, it does not necessarily prevent a user's pre-recorded voice from being used in an authentication attempt. The systems and techniques described herein use an added sound played during capture of user audio to determine whether the audio is genuine and live.

Some passive listening technologies for voice authentication focus on detecting ambient background sounds like stadium crowd noise or construction activity to help determine whether audio is fabricated. These environmental audio elements are used to make inferences about whether a voice recording is authentic or artificially generated. However, this approach requires background noise, and background noise can also be faked. The systems and techniques described herein use an active interrogation by playing a sound and measuring how the sound interacted with dynamics of a user environment. The active interrogation provides a technical solution to the fake background noise or the no background noise problems, and may be used to detect fabricated audio.

A user environment may be measured for reverb based on audio played during a call. In an example, the reverb measured may be adjusted based on the environment of the user, such as whether the user is using a speaker function of a cell phone or talking via a handheld mode, whether the background environment is large or small, whether the background environment is noisy or quiet, etc. The expected reverb in each situation may be quantitatively different (e.g., expected to be relatively louder or softer, take a longer or shorter amount of time to reverb, etc.) or qualitatively different (e.g., dampened, filtered, have more or less noise in the reverb, etc.).

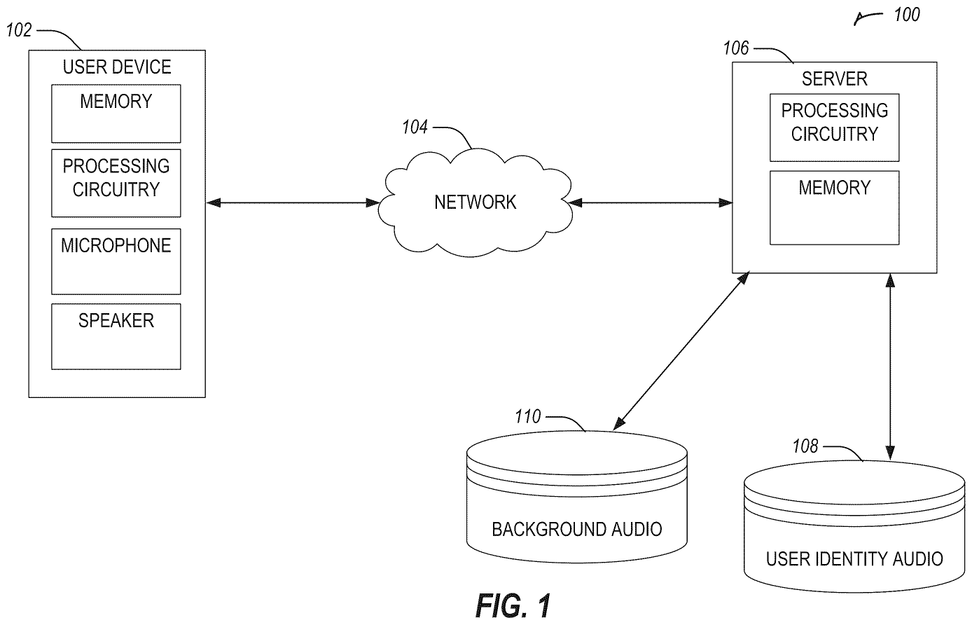

FIG. 1 illustrates a system diagram 100 for voice authentication based on background audio in accordance with some examples. The system diagram 100 includes a user device 102 in communication with a server 106 (e.g., via a network 104, such as the internet, voice network, or the like). The server 106 may include processing circuitry and memory to implement audio processing for authentication. The server 106 may include or be in communication with one or more databases, such as a background audio database 110 to store background audio for sending to the user device 102 or a user identity audio database 108 to store an authentication voice recording. The background audio database 110 and the user identity audio database 108 may be a single database, or may be separate databases. The user device 102 may include memory and processing circuitry for calling the server 106. The user device 102 may include or be coupled to a microphone and a speaker for facilitating playing or recording audio. The background audio database 110 may store example reverb captured audio. The example reverb captured audio may include reverb in different environments for a particular audio sample. The example reverb captured audio may be stored as audio or as a representation (e.g., vector, frequency data, etc.).

In an example, a user of the user device 102 may store a profile with the server 106 (e.g., in the user identity audio database 108), for example at an initial registration. The user device 102 may initiate an interaction with the server 106 to authenticate a user of the user device 102 (e.g., for a transaction). The interaction may be authenticated with a voice sample captured at the user device 102 by comparing to a pre-stored user identity audio stored in the user identity audio database 108. During the interaction, the server 106 may play audio that is output by the speaker of the user device 102. The microphone of the user device 102 may capture audio spoken by the user. The microphone of the user device 102 may capture audio in a background environment of the user device 102, such as reverb from the audio played by the server 106 during the interaction. The reverb from the audio may be compared to stored reverb information (e.g., at the background audio database 110) to determine whether the reverb occurred or whether the reverb occurred in a particular environment. For example, where reverb is not present, is limited, or does not match stored reverb information, an authentication request from the user device 102 may be denied or escalated (e.g., require a second factor of authentication). When reverb matches stored reverb information, the user may be authenticated via voice (e.g., voice alone).

The background audio database 110 may store a profile for a user (e.g., a particular user tends to be in a noisy environment) or an overall trend. For example, while a scammer may be replicating live audio, the scammer may be in a particular environment causing exact or very close reverb matches across different calls in a short period of time (e.g., ten minutes). The reverb from one call may be compared against reverb from another call.

In an example, the server 106 may record audio corresponding to a background of a call with the user device 102. Background audio may be recorded (with or without user vocalizations). The background room noise or resonance may be used to determine whether a caller is calling from a same room but with different credentials (e.g., to fraudulently attempt to authenticate under different names, numbers, etc.). When there is no background room noise or resonance, the call may be subjected to heightened authentication (e.g., multi-factor) due to the likelihood that the sound is synthesized. In some examples, the background audio recording and checking may not prevent a scam, but may increase costs to produce synthetic audio, making it economically less viable to be a scammer.

The server 106 may play an impulse sound with a set of tones in a short period of time and record sound coming back from the user device 102. The server 106 may perform a frequency analysis on the recording, and based on the known set of tones previously played, identify resonance or echo for each tone of the set of tones. The resonances may be stored in a querying structure (e.g., via an encoder, and stored in a vector database). Frequency position and width of the resonances may be recorded. Using these details, the resonances can be checked against previously recorded resonances (e.g., to see if these are repeat resonances, suggesting a common room or area of a scammer). What tones are played may be changed, such as daily, weekly, monthly, etc. to limit the ability of scammers to pre-record synthetic audio with matching resonances. The resonances may be searched against previously recorded resonances using a vector search. In some examples, a call may begin with a questionnaire, such as asking a user what the user device 102 is, such as a speakerphone, headphones, a regular cell phone, a webcam, etc. This information may be used to determine whether the resonances will be available or how they may be distorted (e.g., headphones may have more minimal resonances than a speakerphone.

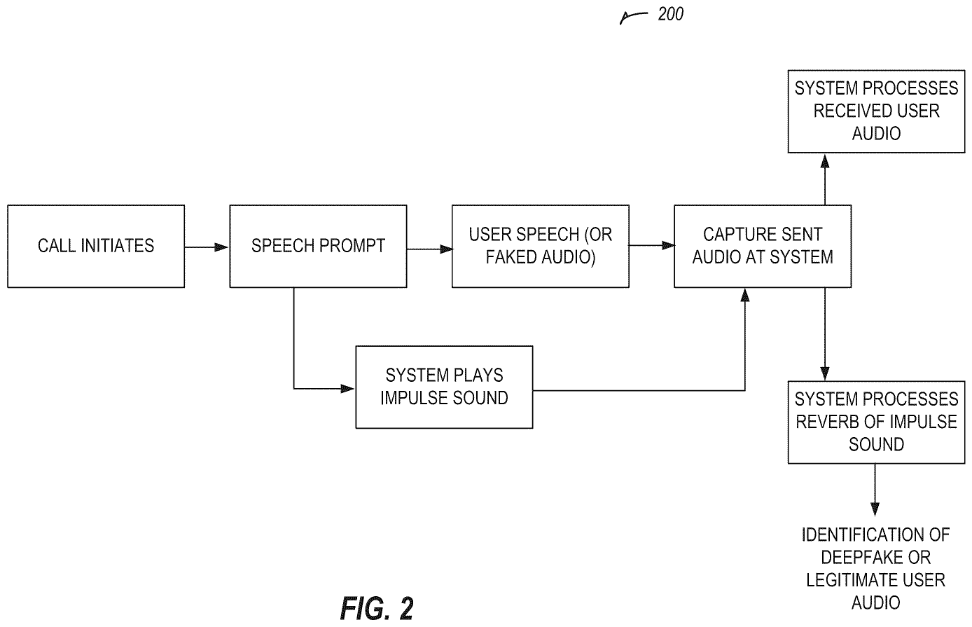

FIG. 2 illustrates a background audio assessment workflow 200 in accordance with some examples. In the workflow 200, a call is initiated. A speech prompt may be sent (e.g., by a receiver of the call, such as at an authentication service, call center, etc.), such as “say your name” or “say the last four digits of your phone number.” The caller may respond with user speech or faked audio. As the user is speaking or the fake audio is playing (e.g., before, during, or after the user speech or faked audio occurs), an impulse sound may be played. Audio may be captured at a service or system, including the user speech or faked audio, and reverb from the impulse sound, if any. The captured audio may be separated into reverb of the impulse sound and user or faked audio. The reverb may be processed to determine whether the audio is fake or legitimate. When the audio is legitimate, the user audio may be processed for authentication or identity, in some examples.

The reverb may be compared to a threshold to determine whether the audio is legitimate. For example, the reverb may be compared using a decay value of the impulse sound. When a decay value of the reverb matches (e.g., within a range) a decay value of the impulse sound, the audio may be indicated as authentic. In examples where a user is wearing headphones, the impulse sound may not be picked up by a microphone of the user, and the reverb may be absent. The user may be asked whether they are wearing headphones, and if so, the absence of reverb may indicate legitimate audio. When the user indicates they are not wearing headphones and there is no reverb, that combination may indicate malicious audio.

In some examples, an impulse sound playing in background audio at the user device may be used instead of or in addition to a system-played impulse sound. For example, human speech may be separated from background noise in received audio at the system. The system may identify an impulse sound in the background audio after separation. The background impulse sound may be compared to the human speech to determine whether a decay rate of the background impulse sound is correlated with decay of the human speech (e.g., within a range of decay). The impulse sound may include multiple sounds, such as those with varying acoustic characteristics, including different tones, different volumes, different overtones, etc. Multiple impulse tones may be played overlapping (e.g., simultaneously) or sequentially.

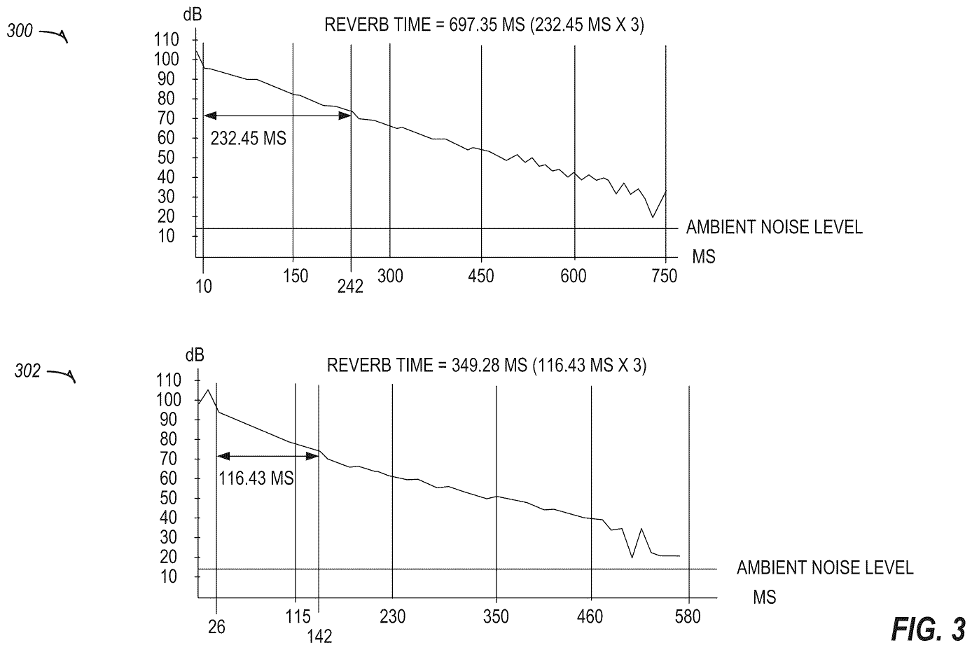

FIG. 3 illustrates example sound reverb time graphs 300 and 302 in accordance with some examples. The sound reverb time graph 300 illustrates that in a measured room, the decay rate for an impulse tone to go from around 90 decibels to around 30 decibels occurs in approximately 700 milliseconds. The sound reverb time graph 302 illustrates that in the same measured room, the decay rate for a reverb of the impulse tone to go from around 90 decibels to around 30 decibels occurs in approximately 500 milliseconds. The decay rates shown on both graphs fall off in a consistent manner, suggesting that the reverb is real, and corresponds to the impulse tone's decay rate. This shows sound intensity following impulse sounds decay with time as a function of the physical environment. In a call setting, the decay rate for the impulse tone may be estimated or selected based on testing the impulse tone in various physical environments. The decay rate of the reverb is measured for the call and compared to the impulse tone decay rate. In some examples, during a call only the reverb decay rate is measured, and not the impulse tone decay rate. In some examples, a tonal resonance analysis may be used for determining room size or characteristics the tonal resonance analysis may occur in testing environments (e.g., before a call), or during a call using different impulse tones. The reverb decay rate may be predicted based on the tonal resonance analysis and characteristics of the impulse tone. A recorded reverb decay rate may be compared to the predicted reverb decay rate, and when within a particular range, may be used to determine whether the call is genuine or synthetic.

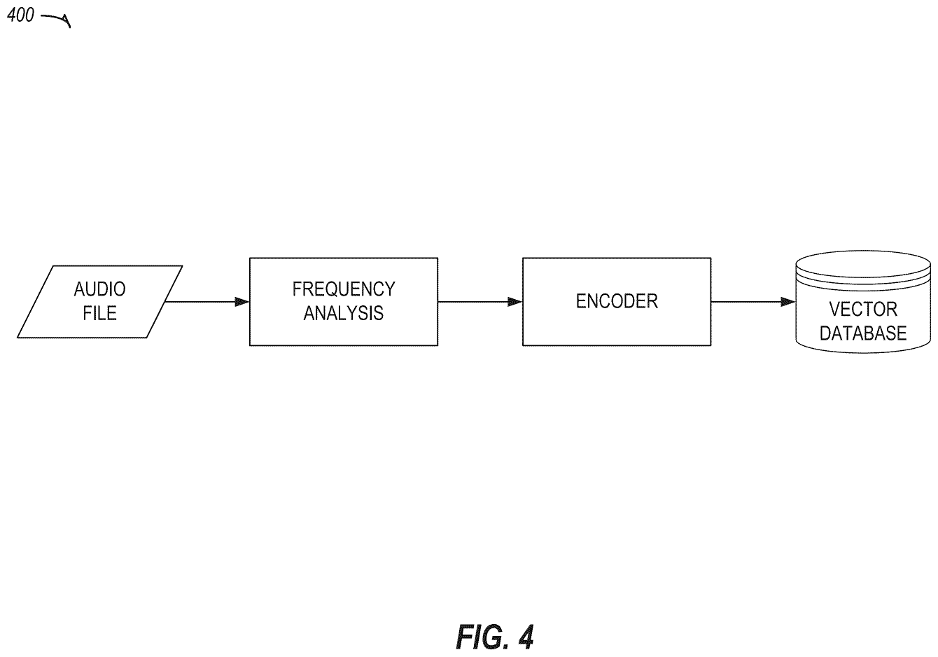

FIG. 4 illustrates an audio processing workflow 400 in accordance with some examples. The audio processing workflow 400 includes starting with an audio file (e.g., received during a call, retrieved from a database, etc.) and performing a frequency analysis on the audio file. Processed audio from the frequency analysis may go through an encoder and be stored in a database (e.g., a vector database). The encoder may create a vector representation of the audio based on the frequency analysis.

Audio from calls may be stored in the vector database for later consideration during a live call to determine whether the live call is genuine or synthetic. Audio during a call may be compared to historical audio data for the customer purportedly on the call. In some examples, audio during a call may be compared to historical audio data for a set of customers (e.g., customers of a particular enterprise), instead of or in addition to historical audio data for the customer. Audio during a call may be vectorized as described in the audio processing workflow 400, and then comparted to other audio files in the vector database. When there is a match for the customer to the customer's previous audio, the match may indicate that the call is genuine. However, when there is a match for the call to other customer's audio, that match may indicate that the call is synthetic. For example, a scammer may reuse audio, repeatedly generate audio in a same room while pretending to be different customers, etc. Prior to storing a new interaction, the vector database may be queried for matches (e.g., to avoid storing duplicates).

The vector database may store audio data according to a schema, such as {vector, uuid (session)}. One or more values of peaks and width of the audio may be encoded in the vector. When combined with an interrogation tone, resonances may be linked to measure room size or asymmetry. The size or asymmetry do not need to be measured directly, but may be filtered as room resonance data before encoding to enhance the specificity of a vector similarity search. For example, at times during a call where no speech is occurring, the background noise may be captured and used to filter later speech audio.

In some examples, during a call, a caller may be directed to provide specific biometric feedback, such as asking the caller to repeat a word or phrase, repeat what they have recently said, or behave in a specific way to fine tune the audio for vectorizing (e.g., sing, hum, speak loudly or softly, etc.). In some examples, how long it takes the caller to answer an interrupted question may be used to compare to how the caller answered other questions to see if there is a delay. If it takes the caller the same time to answer all questions, they are likely a bot.

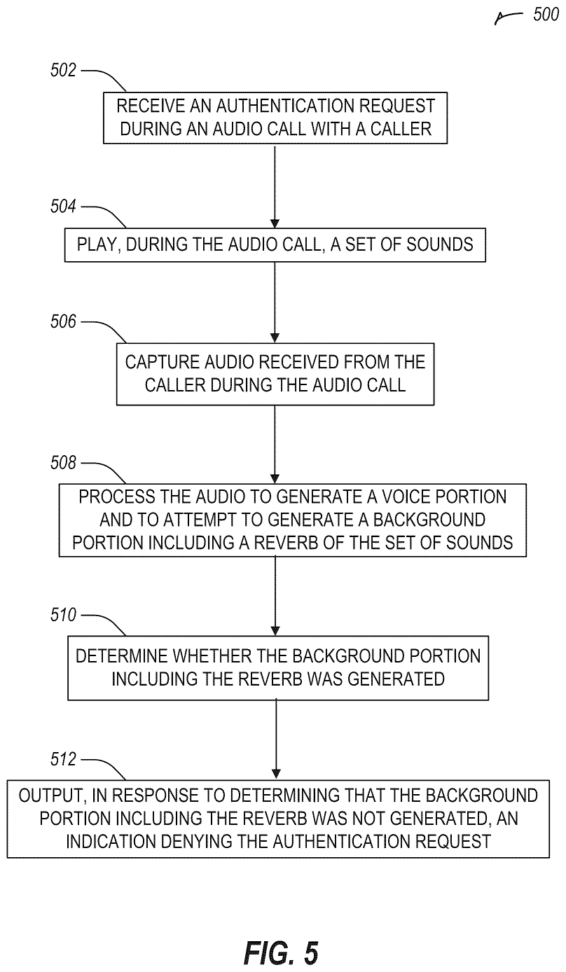

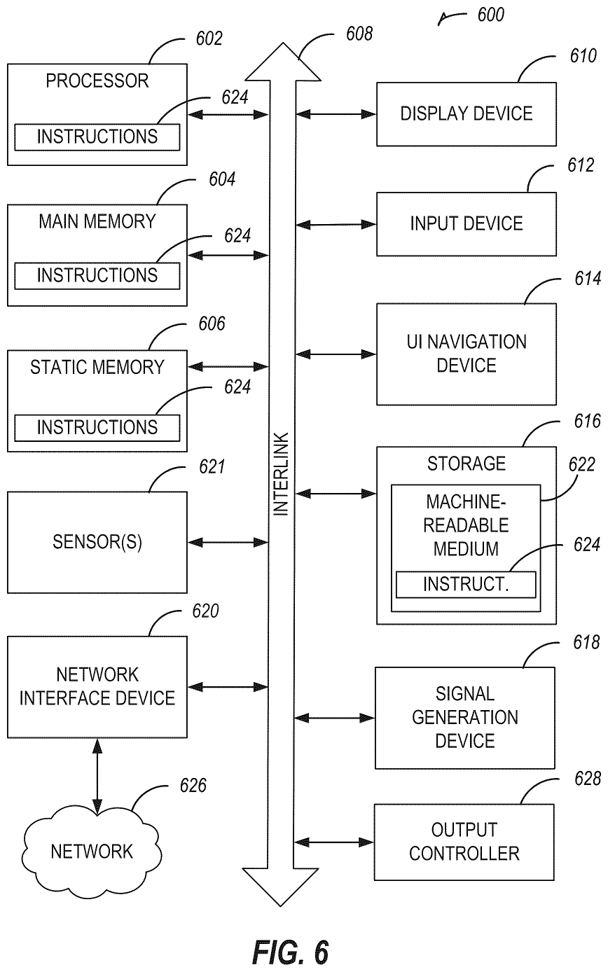

FIG. 5 illustrates a flowchart showing a technique 500 for voice authentication based on background audio in accordance with some examples. In an example, operations of the technique 500 may be performed by processing circuitry, for example by executing instructions stored in memory. The processing circuitry may include a processor, a system on a chip, or other circuitry (e.g., wiring). For example, the technique 500 may be performed by processing circuitry of a device (or one or more hardware or software components thereof), such as those illustrated and described with reference to FIG. 6.

The technique 500 includes an operation 502 to receive an authentication request during an audio call with a caller. The technique 500 includes an operation 504 to play, during the audio call, a set of sounds. One or more sounds in the set of sounds may have a particular acoustic characteristic. The respective acoustic characteristic may include at least one of a number of overtones, a frequency, a frequency range, a number of pulses, a duration, a volume, or the like. The technique 500 includes an operation 506 to capture audio received from the caller during the audio call. The audio may include voice data purportedly from the caller.

The technique 500 includes an operation 508 to process the audio to generate a voice portion and to attempt to generate a background portion including a reverb of the set of sounds. In an example, to attempt to generate the background portion including the reverb includes identifying a decay reverb of at least one sound of the set of sounds. the reverb including identifying.

The technique 500 includes an operation 510 to determine whether the background portion including the reverb was generated. Operation 510 may include determining whether any sound other than the voice portion including the voice data is in the audio. Operation 510 may include comparing a non-voice data portion of the audio to a set of previous recorded background audio data corresponding to authentication attempts by the caller. Operation 510 may include comparing a non-voice data portion of the audio to a previously recorded environmental background data of the caller. Operation 510 may include performing a tonal resonance analysis of the audio to determine a room characteristic. Operation 510 may include comparing a non-voice data portion of the audio to previously recorded environmental background data of other callers.

The technique 500 may include an operation 512 to output, in response to determining that the background portion including the reverb was not generated, an indication denying the authentication request. In another example, the technique may include an operation, instead of operation 512, to output an indication authorizing the authentication request in response to determining that the background portion including the reverb was generated. The authentication request may include a request for access to a banking service. The technique 500 may include changing the indication denying the authentication request in response to determining that the caller was wearing headphones during the audio call.

FIG. 6 illustrates generally an example of a block diagram of a machine 600 upon which any one or more of the techniques (e.g., methodologies) discussed herein may perform in accordance with some examples. In alternative examples, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a display unit 610, an alphanumeric input device 612 (e.g., a keyboard), and a user interface (UI) navigation device 614 (e.g., a mouse). In an example, the display unit 610, alphanumeric input device 612 and UI navigation device 614 may be a touch screen display. The machine 600 may additionally include a storage device (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 616 may include a machine readable medium 622 that is non-transitory on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 may constitute machine readable media.

While the machine readable medium 622 is illustrated as a single medium, the term “machine readable medium” may include a single medium or multiple media (e.g., a centralized or distributed database, or associated caches and servers) configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 600, and includes digital or analog communications signals or other intangible medium to facilitate communication of such software.

The following, non-limiting examples, detail certain aspects of the present subject matter to solve the challenges and provide the benefits discussed herein, among others.

Example 1 is a method comprising: receiving an authentication request during an audio call with a caller; playing, during the audio call, a set of sounds, each sound within the set of sounds having a respective acoustic characteristic; capturing audio received from the caller during the audio call, the audio including voice data purportedly from the caller; processing the audio to generate a voice portion including the voice data and to attempt to generate a background portion including a reverb of the set of sounds; determining whether the background portion including the reverb was generated; and in response to determining that the background portion including the reverb was not generated, outputting an indication denying the authentication request.

In Example 2, the subject matter of Example 1 includes, wherein the respective acoustic characteristic includes at least one of a number of overtones, a frequency, a frequency range, a number of pulses, a duration, or a volume.

In Example 3, the subject matter of Examples 1-2 includes, wherein to attempt to generate the background portion including the reverb includes identifying a decay reverb of at least one sound of the set of sounds.

In Example 4, the subject matter of Examples 1-3 includes, wherein determining whether the background portion including the reverb was generated includes determining whether any sound other than the voice portion including the voice data is in the audio.

In Example 5, the subject matter of Examples 1-4 includes, wherein determining whether the background portion including the reverb was generated includes comparing a non-voice data portion of the audio to a set of previous recorded background audio data corresponding to authentication attempts by the caller.

In Example 6, the subject matter of Examples 1-5 includes, wherein determining whether the background portion including the reverb was generated includes comparing a non-voice data portion of the audio to a previously recorded environmental background data of the caller.

In Example 7, the subject matter of Examples 1-6 includes, wherein determining whether the background portion including the reverb was generated includes performing a tonal resonance analysis of the audio to determine a room characteristic.

In Example 8, the subject matter of Examples 1-7 includes, wherein determining whether the background portion including the reverb was generated includes comparing a non-voice data portion of the audio to previously recorded environmental background data of other callers.

In Example 9, the subject matter of Examples 1-8 includes, changing the indication denying the authentication request in response to determining that the caller was wearing headphones during the audio call.

In Example 10, the subject matter of Examples 1-9 includes, wherein the authentication request includes a request for access to a banking service.

Example 11 is at least one non-transitory machine-readable medium including instructions, which when executed by processing circuitry, causes the processing circuitry to perform operations comprising: receiving an authentication request during an audio call with a caller; playing, during the audio call, a set of sounds, each sound within the set of sounds having a respective acoustic characteristic; capturing audio received from the caller during the audio call, the audio including voice data purportedly from the caller; processing the audio to generate a voice portion including the voice data and to attempt to generate a background portion including a reverb of the set of sounds; determining whether the background portion including the reverb was generated; and in response to determining that the background portion including the reverb was not generated, outputting an indication denying the authentication request.

In Example 12, the subject matter of Example 11 includes, wherein the respective acoustic characteristic includes at least one of a number of overtones, a frequency, a frequency range, a number of pulses, a duration, or a volume.

In Example 13, the subject matter of Examples 11-12 includes, wherein to attempt to generate the background portion including the reverb includes identifying a decay reverb of at least one sound of the set of sounds.

In Example 14, the subject matter of Examples 11-13 includes, wherein determining whether the background portion including the reverb was generated includes determining whether any sound other than the voice portion including the voice data is in the audio.

In Example 15, the subject matter of Examples 11-14 includes, wherein determining whether the background portion including the reverb was generated includes comparing a non-voice data portion of the audio to a set of previous recorded background audio data corresponding to authentication attempts by the caller.

In Example 16, the subject matter of Examples 11-15 includes, wherein determining whether the background portion including the reverb was generated includes comparing a non-voice data portion of the audio to a previously recorded environmental background data of the caller.

In Example 17, the subject matter of Examples 11-16 includes, wherein determining whether the background portion including the reverb was generated includes performing a tonal resonance analysis of the audio to determine a room characteristic.

In Example 18, the subject matter of Examples 11-17 includes, wherein determining whether the background portion including the reverb was generated includes comparing a non-voice data portion of the audio to previously recorded environmental background data of other callers.

In Example 19, the subject matter of Examples 11-18 includes, changing the indication denying the authentication request in response to determining that the caller was wearing headphones during the audio call.

In Example 20, the subject matter of Examples 11-19 includes, wherein the authentication request includes a request for access to a banking service.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

What is claimed is:

1. A method comprising:
receiving an authentication request during an audio call with a caller;
playing, during the audio call, a set of sounds, each sound within the set of sounds having a respective acoustic characteristic;
capturing audio received from the caller during the audio call, the audio including voice data purportedly from the caller;
processing the audio to generate a voice portion including the voice data and to attempt to generate a background portion including a reverb of the set of sounds;
determining whether the background portion including the reverb was generated; and
in response to determining that the background portion including the reverb was not generated, outputting an indication denying the authentication request.

2. The method of claim 1, wherein the respective acoustic characteristic includes at least one of a number of overtones, a frequency, a frequency range, a number of pulses, a duration, or a volume.

3. The method of claim 1, wherein to attempt to generate the background portion including the reverb includes identifying a decay reverb of at least one sound of the set of sounds.

4. The method of claim 1, wherein determining whether the background portion including the reverb was generated includes determining whether any sound other than the voice portion including the voice data is in the audio.

5. The method of claim 1, wherein determining whether the background portion including the reverb was generated includes comparing a non-voice data portion of the audio to a set of previous recorded background audio data corresponding to authentication attempts by the caller.

6. The method of claim 1, wherein determining whether the background portion including the reverb was generated includes comparing a non-voice data portion of the audio to a previously recorded environmental background data of the caller.

7. The method of claim 1, wherein determining whether the background portion including the reverb was generated includes performing a tonal resonance analysis of the audio to determine a room characteristic.

8. The method of claim 1, wherein determining whether the background portion including the reverb was generated includes comparing a non-voice data portion of the audio to previously recorded environmental background data of other callers.

9. The method of claim 1, further comprising changing the indication denying the authentication request in response to determining that the caller was wearing headphones during the audio call.

10. The method of claim 1, wherein the authentication request includes a request for access to a banking service.

11. At least one non-transitory machine-readable medium including instructions, which when executed by processing circuitry, causes the processing circuitry to perform operations comprising:
receiving an authentication request during an audio call with a caller;
playing, during the audio call, a set of sounds, each sound within the set of sounds having a respective acoustic characteristic;
capturing audio received from the caller during the audio call, the audio including voice data purportedly from the caller;
processing the audio to generate a voice portion including the voice data and to attempt to generate a background portion including a reverb of the set of sounds;
determining whether the background portion including the reverb was generated; and
in response to determining that the background portion including the reverb was not generated, outputting an indication denying the authentication request.

12. The at least one non-transitory machine-readable medium of claim 11, wherein the respective acoustic characteristic includes at least one of a number of overtones, a frequency, a frequency range, a number of pulses, a duration, or a volume.

13. The at least one non-transitory machine-readable medium of claim 11, wherein to attempt to generate the background portion including the reverb includes identifying a decay reverb of at least one sound of the set of sounds.

14. The at least one non-transitory machine-readable medium of claim 11, wherein determining whether the background portion including the reverb was generated includes determining whether any sound other than the voice portion including the voice data is in the audio.

15. The at least one non-transitory machine-readable medium of claim 11, wherein determining whether the background portion including the reverb was generated includes comparing a non-voice data portion of the audio to a set of previous recorded background audio data corresponding to authentication attempts by the caller.

16. The at least one non-transitory machine-readable medium of claim 11, wherein determining whether the background portion including the reverb was generated includes comparing a non-voice data portion of the audio to a previously recorded environmental background data of the caller.

17. The at least one non-transitory machine-readable medium of claim 11, wherein determining whether the background portion including the reverb was generated includes performing a tonal resonance analysis of the audio to determine a room characteristic.

18. The at least one non-transitory machine-readable medium of claim 11, wherein determining whether the background portion including the reverb was generated includes comparing a non-voice data portion of the audio to previously recorded environmental background data of other callers.

19. The at least one non-transitory machine-readable medium of claim 11, further comprising changing the indication denying the authentication request in response to determining that the caller was wearing headphones during the audio call.

20. The at least one non-transitory machine-readable medium of claim 11, wherein the authentication request includes a request for access to a banking service.
